(19) United States
(12) Patent Application Publication
(10) Pub. No.: US 2007/0216304 A1
(43) Pub. Date: Sep. 20, 2007

(54) Plasma display panel

(76) Inventors: Jae-Ik Kwon, Suwon-si (KR); Won-Ju Yi, Suwon-si (KR); Ho-Young Ahn, Suwon-si (KR); Kyoung-Doo Kang, Suwon-si (KR); Dong-Young Lee, Suwon-si (KR); Soo-Ho Park, Suwon-si (KR); Seok-Gyun Woo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/714,262

(22) Filed: Mar. 6, 2007

(30) Foreign Application Priority Data
Mar. 6, 2006 (KR) 10-2006-0020952

(51) Int. Cl. H01J 17/49

(52) U.S. Cl. 313/582; 313/584

(57) ABSTRACT

A plasma display panel (PDP) having increased exhaustion capacity, includes a first substrate, a second substrate spaced apart from the first substrate and having an exhaustion hole, first and second sealing members, and an electrode sheet with at least one exhaustion path, the electrode sheet disposed between the first substrate and the second substrate and having a discharge area and an undischarge area.

### BACKGROUND OF THE INVENTION

1. Field of the Invention

The present invention relates to a plasma display panel (PDP). In particular, the present invention relates to a PDP having an improved exhaustion capacity.

2. Description of the Related Art

Plasma display panels (PDPs) are flat display panels capable of displaying images using gas discharge phenomenon, thereby providing superior display properties such as high brightness and contrast, lack of residual image, wide viewing angles, and a thin display structure.

The conventional PDP may include two substrates with a plurality of discharging electrodes therebetween, i.e., a plurality of address electrodes and pairs of sustain electrodes, barrier ribs defining a plurality of discharge cells, and phosphorescent layers coated onto sidewalls of the barrier ribs. A predetermined amount of electricity may be applied to the discharging electrodes, thereby generating a sustain discharge in the discharge cells to trigger ultraviolet (UV) emission and excite the phosphorescent layers to emit light and form images.

The conventional PDP may also require exhaustion of any impurities from the discharge cells. However, the structure of the conventional PDP may include discharge cells surrounded by barrier ribs, such that removal of impurities from the discharge cells may be difficult.

Accordingly, there exists a need to provide a PDP with a structure capable of enhancing exhaustion of impurity gas therefrom.

### SUMMARY OF THE INVENTION

The present invention is therefore directed to a plasma display panel (PDP), which substantially overcomes one or more of the disadvantages of the related art.

It is therefore a feature of an embodiment of the present invention to provide a PDP having an improved exhaustion capacity.

At least one of the above and other features and advantages of the present invention may be realized by providing a PDP, including a first substrate; a second substrate spaced apart from the first substrate, the second substrate having an exhaustion hole; an electrode sheet disposed between the first substrate and the second substrate, the electrode sheet having a discharge area and an undischarge area, and wherein the electrode sheet includes at least one exhaustion path; a first sealing member between the first substrate and the electrode sheet; and a second sealing member between the second substrate and the electrode sheet. The electrode sheet may be longer than each of the first and second substrates.

The exhaustion path may be in the undischarge area of the electrode sheet. Further, the exhaustion path may be positioned along an inner perimeter of the electrode sheet. The exhaustion path may have a shape of a looped curve.

The exhaustion hole may correspond to the undischarge area. The exhaustion hole may be aligned with a region of the exhaustion path. Further, the exhaustion hole may be below a region of the exhaustion path.

The electrode sheet may include two exhaustion paths. Each exhaustion path may be on a different surface of the electrode sheet. The two exhaustion paths may be aligned.

The first substrate may include a plurality of grooves and phosphor layers, each phosphor layer positioned inside a respective groove and above a respective discharge cell.

The electrode sheet may include a plurality of first discharge electrodes spaced apart from one another and a plurality of second discharge electrodes spaced apart from one another, the plurality of the first discharge electrodes extends on a plane parallel to a plane of the second discharge electrodes, and each of the pluralities of first and second discharge electrodes includes a plurality of shapes surrounding a corresponding number of discharge cells. Further, each of the plurality of the first discharge electrodes may cross the plurality of the second discharge electrodes. The electrode sheet may further include a plurality of address electrodes on a plane positioned between the plane of the plurality of the first discharge electrodes and the plane of the plurality of the second discharge electrodes and parallel thereto, each of the plurality of address electrodes includes a plurality of shapes surrounding a corresponding number of discharge cells.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a perspective view of a PDP according to an embodiment of the present invention;

FIG. 2 illustrates a partially enlarged exploded perspective view of the PDP illustrated in FIG. 1;

FIG. 3 illustrates a cross-sectional view of the PDP taken along line III-III in FIG. 1;

FIG. 4 illustrates a plan view of an electrode sheet illustrated in FIG. 1;

FIG. 5 illustrates a schematic diagram of discharge cells and first and second discharge electrodes of the PDP illustrated in FIG. 2;

FIG. 6 illustrates a cross-sectional view of a PDP according to a comparative example;

FIG. 7 illustrates a plan view of an electrode sheet illustrated in FIG. 6;

FIG. 8 illustrates a partially enlarged exploded perspective view of a PDP according to another embodiment of the present invention; and

FIG. 9 illustrates a schematic diagram of discharge cells, address electrodes, and first and second discharge electrodes of the PDP illustrated in FIG. 8.

### DETAILED DESCRIPTION OF THE INVENTION

Korean Patent Application No. 10-2006-0020952, filed on Mar. 6, 2006, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, or one or more intervening layers may also be present. In addition, it will also be understood that when a layer is referred to as being “between” two layers, it can be the only layer between the two layers, or one or more intervening layers may also be present. Like reference numerals refer to like elements throughout.

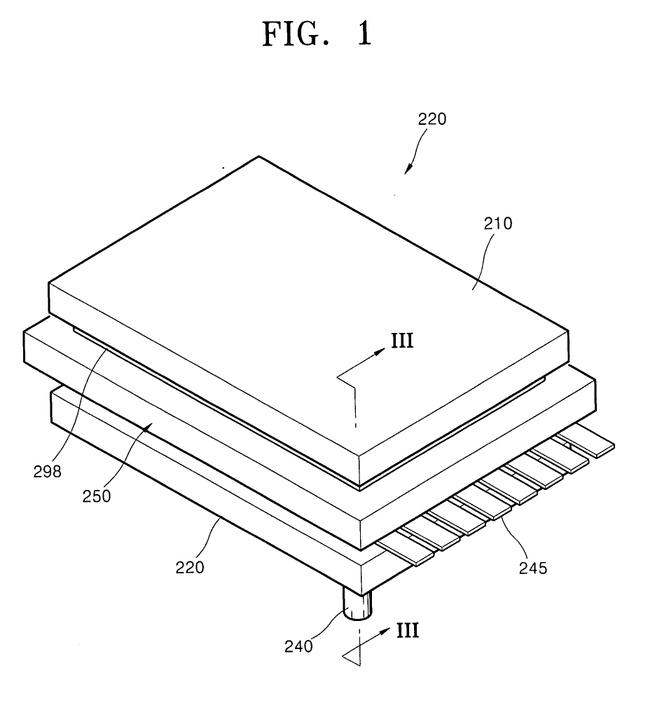

An exemplary embodiment of a plasma display panel (PDP) according to the present invention will be described more fully with reference to FIGS. 1-4.

As illustrated in FIGS. 1-4, a plasma display panel (PDP) 200 according to an embodiment of the present invention may include a first substrate 210, a second substrate 220, an electrode sheet 250 with at least one exhaustion path 251, a plurality of phosphor layers 225, a first sealing member 298, and a second sealing member 299.

The first substrate 210 may be made of a material having excellent light transmitting properties, e.g., glass. Additionally, the first substrate 210 may be colored in order to reduce reflection brightness and, thereby, improve bright room contrast. Similarly, the second substrate 220 may also be colored and made of a material having excellent light transmitting properties, e.g., glass. Additionally, the first and second substrates 210 and 220 may be spaced apart from each other by a predetermined distance, such that the electrode sheet 250 may be positioned therebetween.

The first substrate 210 may include a plurality of grooves 210a. The plurality of grooves 210a may be formed as parallel channels on a surface of the first substrate 210 above respective discharge cells 230. Without intending to be bound by theory, it is believed that formation of the grooves 210a in the first substrate 210 may reduce the thickness of the first substrate 210 and, thereby, improve visible light transmission therethrough. In particular, visible light radiated from the discharge cells 230 may be emitted directly through the first substrate 210 due to reduced thickness thereof and minimized number of elements disposed thereon. In other words, the PDP 200 according to the present invention may include phosphor layers 225 as the only light absorbing element on the first substrate 210, thereby providing improved light transmission therethrough as compared to the conventional art.

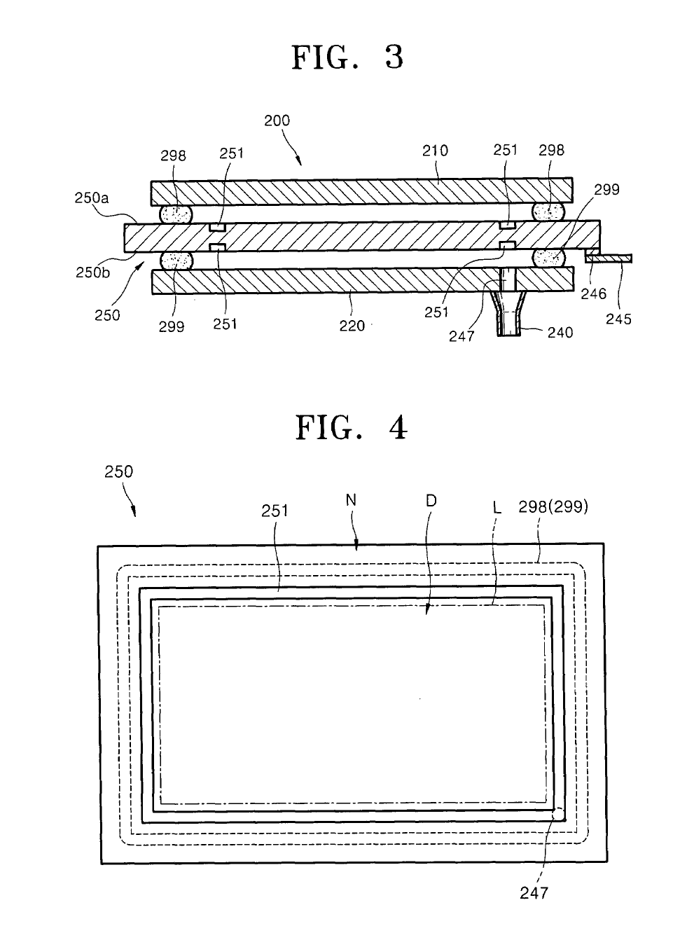

The electrode sheet 250 of the PDP 200 according to an embodiment of the present invention may include a plurality of barrier ribs 214, a plurality of pairs of first and second discharge electrodes 260 and 270, respectively, and at least one exhaustion path 251. A length of the electrode sheet 250 may be longer than each of the first and second substrates 210 and 220, as measured along a horizontal axis, such that at least one edge of the electrode sheet 250 may extend beyond the first and second substrates 210 and 220 to include at least one signaling member 245, as illustrated in FIG. 3.

The signaling member 245, e.g., a flexible printed cable (FPC), a tape carrier package (TCP), a chip-on-film (COF), and so forth, may be attached to the electrode sheet 250 via anisotropic conductive films 246.

The barrier ribs 214 of the electrode sheet 250 may be formed of a dielectric material to facilitate induction and accumulation of wall charges.

Additionally, the barrier ribs 214 may be formed in any convenient shape as determined by one of ordinary skill in the art to have a plurality of volumetric structures therebetween to define a plurality of discharge cells 230, i.e., where discharge occurs, and undischarge cells (not shown), i.e., where discharge does not occur. In particular, as illustrated in FIG. 4, the electrode sheet 250 may be divided into a discharge area D, an undischarge area N surrounding the discharge area D and, and a terminal region (not shown), such that barrier ribs 214 defining the plurality of discharge cells 230 may be located in the discharge area D and barrier ribs 214 defining the plurality of undischarge cells may be located in the undischarge area N. A boundary between the discharge area D and the undischarge area N is indicated in FIG. 4 by a dot-dash line L.

The plurality of discharge cells 230 and undischarge cells may be formed between the barrier ribs 214 to have any polygonal cross section as determined by one of ordinary skill in the art, e.g., cylindrical, triangular, pentagonal, elliptical, and so forth. In particular, the plurality of discharge cells 230 may be formed as a matrix, i.e., a plurality of rows and columns. The plurality of discharge cells 230 of the electrode sheet 250 according to an embodiment of the present invention may include a discharge gas, e.g., neon (Ne), xenon (Xe), or a mixture thereof, to accommodate proper plasma discharge.

The plurality of pairs of first and second discharge electrodes 260 and 270 of the electrode sheet 250 may be disposed in barrier ribs 214, such that each of the first discharge electrodes 260 may be paired with a respective second discharge electrode 270 to generate a discharge in the discharge cells 230 positioned therebetween. The plurality of pairs of first and second discharge electrodes 260 and 270 may serve as scan/sustain electrodes and address/sustain electrodes, e.g., first discharge electrodes 260 may operate as scan/sustain electrodes, and the second discharge electrodes 270 may operate as address/sustain electrodes, or vice versa.

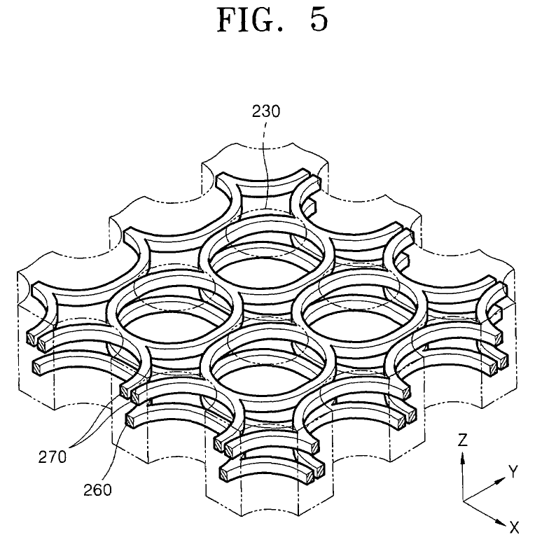

More specifically, as illustrated in FIG. 5, each of the first discharge electrodes 260 may include a plurality of tangential identical circles arranged sequentially into a single linear array along the x-axis, such that each circle of the plurality of circles may surround a single discharge cell 230. The plurality of first discharge electrodes 260 may be arranged parallel to one another, such that a small gap may be formed between every two first discharge electrodes 260. In this respect, it should be noted that “tangential circles” refer to circles that may touch one another at only one point, such that no other intersecting points may be formed between the circles, i.e., a cross-section along a tangent point of two circles may show a single point of contact.

Similarly, as further illustrated in FIG. 5, each of the second discharge electrodes 270 may include a plurality of tangential identical circles arranged sequentially into a single linear array along the y-axis, such that each second discharge electrode 270 may be positioned at a right angle to the plurality of first discharge electrodes 260. Each circle of the plurality of circles of each second discharge electrode 270 may be positioned above a respective circle of a respective first discharge electrode 260 to surround a discharge cell 230, such that each discharge cell 230 may be surrounded by two electrode circles. The plurality of second discharge electrodes 270 may be arranged parallel to one another, such that a small gap may be formed between every two second discharge electrodes 270. Additionally, a plane formed by the plurality of the second discharge electrodes 270 may be adjacent and parallel to a plane formed by the first discharge electrodes 260. Further, the planes of the first and second discharge electrodes 260 and 270 may have a gap therebetween along the z-axis, as illustrated in FIG. 5.

In this respect, it should be noted that even though the present embodiment, illustrated with respect to FIG. 5, includes identical circles, wherein the first discharge electrode 260 is positioned below the second discharge electrode 270, other configurations of electrode shapes and positions are not excluded from the scope of the present invention. For example, the plurality of the first discharge electrodes 260 may be positioned above the plurality of the second discharge electrodes 270.

The first and second discharge electrodes 260 and 270 may be formed of a conductive metal, e.g., aluminum, copper, and so forth.

Accordingly, and without intending to be bound by theory, it is believed that small voltage drops in the directions of the first and second discharge electrodes 260 and 270, i.e., x-axis and y-axis, may stabilize signal transmission.

Additionally, the first and second discharge electrodes 260 and 270 may be formed inside the barrier ribs 214, thereby minimizing blocking of transmission of visible light. Further, the barrier ribs 214 may prevent direct electrical conduction between the first and second discharge electrodes 260 and 270, and, thereby, minimize collision of positive ions or electrons therewith in order to reduce potential damage to the first and second discharge electrodes 260 and 270.

The exhaustion paths 251 of the electrode sheet 250 may be formed in the undischarge area N of the electrode sheet 250 to a predetermined depth. In particular, as illustrated in FIGS. 3-4, one exhaustion path 251 may be formed on each surface, i.e., on an upper surface 250a and on a lower surface 250b, of the electrode sheet 250 in a form of a channel, e.g., a curved loop, along an inner perimeter of the electrode sheet 250. The exhaustion paths 251 may be aligned. In other words, the exhaustion paths 251 may be formed such that a cross-section of one exhaustion path 251 may mirror a cross-section of the other exhaustion path 251 with respect to a center line along a length, i.e., a horizontal direction, of the electrode sheet 250, as illustrated in FIG. 3. However, other positions of the exhaustion path 251 within the electrode sheet 250, e.g., one exhaustion path 251 may be shifted left with respect to the other exhaustion path 251, one exhaustion path 251 may have a smaller perimeter as compared to the other exhaustion path 251, and so forth, are not excluded from the scope of the present invention.

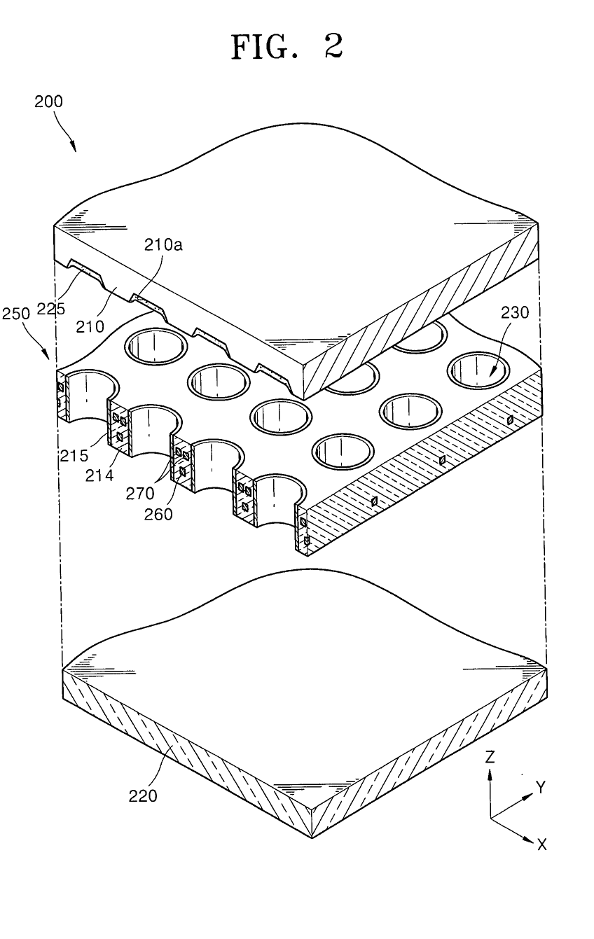

The electrode sheet 250 of the PDP 200 according to an embodiment of the present invention may further include a plurality of protective layers 215. Each protective layer 215 may be formed of magnesium oxide (MgO) on a sidewall of a respective barrier rib 214. In particular, the protective layer 215 may be applied to each inner wall of the discharge cells 230, as illustrated in FIG. 2. Accordingly, the plurality of protective layers 215 may minimize potential damage to the barrier ribs 214 from plasma particles and reduce a discharge voltage by emitting secondary electrons.

The electrode sheet 250 of the PDP 200 according to an embodiment of the present invention may further include a terminal area (not shown) formed on an exposed portion of the electrode sheet 250, i.e., a portion extending beyond the first and second substrates 210 and 220, and electrically connected to the signaling members 245 for connecting the PDP 200 to a drive circuit (not shown).

The plurality of phosphor layers 225 of the PDP 200 according to an embodiment of the present invention may include red, green and blue phosphor layers disposed in the plurality of grooves 210a. In particular, each phosphor layer 225 may be disposed in a respective groove 210a of the first substrate 210, such that plasma discharge from the discharge cell 230 may reach the phosphor layer 225 in the groove 210a. The phosphor layers 225 may include any phosphorescent materials capable of generating visible light upon excitation by UV light. For example, the red light-emitting phosphor layers may include Y(V,P)O4:Eu, the green light-emitting phosphor layers may include Zn₂SiO₄:Mn and YBO₃:Tb, and the blue light-emitting phosphor layers may include BAM:Eu. Without intending to be bound by theory, it is believed that disposing the plurality of phosphor layers 225 in the grooves 210a may improve brightness and luminous efficiency of the PDP 200 because the grooves 210a may increase the size of the phosphor layers 225 employed.

The first sealing members 298 of the PDP 200 according to an embodiment of the present invention may be disposed between the electrode sheet 250 and the first substrate 210 along inner perimeters thereof, such that the first sealing members 298 may attach the first substrate 210 to the electrode sheet 250. Similarly, the second sealing members 299 may be disposed between the electrode sheet 250 and the second substrate 220 along inner perimeters thereof, such that the second sealing members 299 may attach the second substrate 220 to the electrode sheet 250. Accordingly, the discharge cells 230 positioned within the discharge area D of the electrode sheet 250 may be sealed from the exterior by the first and second sealing members 298 and 299. The first sealing members 298 and the second sealing members 299 may be formed of frit glass.

The PDP according to an embodiment of the present invention may further include an exhaustion hole 247 and an exhaustion pipe 240. The exhaustion hole 247 may be formed in the second substrate 220 in a portion corresponding to the undischarge area N of the electrode sheet 250, as illustrated in FIG. 3. In other words, the exhaustion hole 247 may be aligned, i.e., directly below, with the exhaustion paths 251, as further illustrated in FIG. 3, such that fluid may be transferred directly from the exhaustion paths 251 into the exhaustion hole 247. The exhaustion pipe 240 may be formed in communication with the exhaustion hole 247 below the second substrate 200, as further illustrated in FIG. 3. In this respect, it should be noted that “below” may refer to positioning of one element lower than another element along a vertical direction. However, “directly below” may refer to positioning of one element lower than another element along a single vertical axis, i.e., both elements have an identical horizontal position.

### EXAMPLE

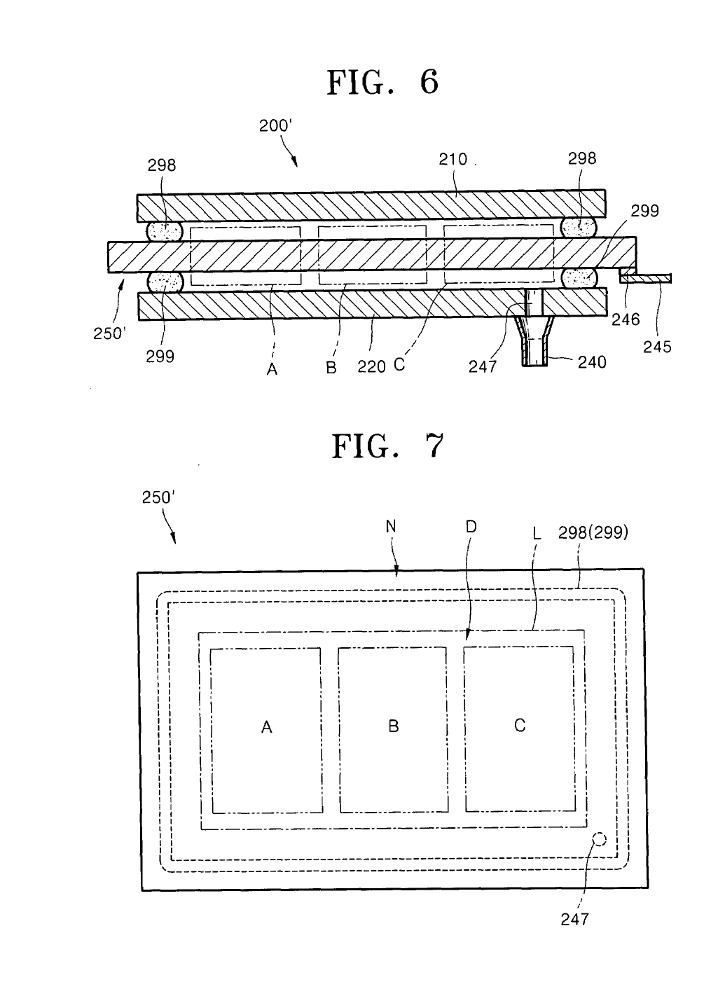

A PDP was manufactured according to an embodiment of the present invention, i.e., as illustrated in FIGS. 3-4, and compared to a conventional PDP 200′ with respect to efficiency of impurity gas exhaustion. The conventional PDP 200′ was manufactured as illustrated in FIGS. 6-7. In other words, the conventional PDP 200′ was manufactured in a manner similar to the PDP 200 with the exception that it lacked exhaustion paths.

Upon examination of exhaustion in the conventional PDP 200′, it was found that while exhaustion was accomplished in a first region C located near the exhaustion hole 247, the efficiency of exhaustion decreased as the horizontal distance from the hole 247 increased. In other words, exhaustion is not effectively accomplished in a second region B and a third region A located far from the exhaustion hole 247 due to a large pressure loss caused by a flow of impurity gas. Therefore, in order to improve exhaustion performance, the heights of first sealing members 298 and second sealing members 299 may be increased to extend a space between the electrode sheet 250′ and first and second substrates 210 and 220. However, since there is a limitation in increasing the heights of the first sealing members 298 and the second sealing members 299, the exhaustion performance improvement is restricted.

Exhaustion in the PDP 200 according to an embodiment of the present invention, as opposed to exhaustion from the conventional PDP 200′, was efficient in all regions due connection of all the regions to the exhaustion path 251.

Formation of the PDP 200 according to the present invention, i.e., a PDP 200 with the exhaustion paths 251, is advantageous as compared to the conventional art. In particular and without intending to be bound by theory, it is believed that formation of the exhaustion paths 251 along the perimeter of the electrode sheet 250 may facilitates more efficient removal of impurities through the exhaustion hole 247. More specifically, the exhaustion paths 251 may connect to regions located further from the exhaustion hole 247, thereby eliminating inefficient impurity removal due to pressure loss and providing enhanced exhaustion of impurity gas in the space enclosed by the first substrate 210, the second substrate 220, the first sealing members 298, and the second sealing members 299.

An exemplary method of driving the PDP 200 is as follows. First, an address discharge may be generated between the first and second discharge electrodes 260 and 270 in order to select the discharge cells 230. Next, an alternating current (AC) sustain voltage may be applied between the first and second discharge electrodes 260 and 270 to generate a sustain discharge in the discharge cells 230, and, subsequently, UV light emission therein. In this respect, it should be noted that the sustain discharge may occur in the entire volumetric space defining each of the discharge cells 230. Subsequently, the UV light may be emitted upward toward the first substrate 210 to excite the plurality of phosphor layers 225 thereon. Excitation of the phosphor layers 225 may emit visible light to form images.

Without intending to be bound by theory, it is believed that the inventive structure of the PDP 200 and the driving method thereof is advantageous because the sustain discharge in the PDP 200 occurs on all sides of the barrier rib portions 214, as opposed to a conventional PDP having a sustain discharge on the first substrate in a horizontal direction only. The sustain discharge in the present invention may diffuse toward center portions of the discharge cells 230 and increase the discharge area and volume as compared to the conventional PDP. It should further be noted that the occurrence of sustain discharge in the central portions of the discharge cells 230 may reduce ion sputtering of phosphor, thereby minimizing burning of permanent images into the PDP.

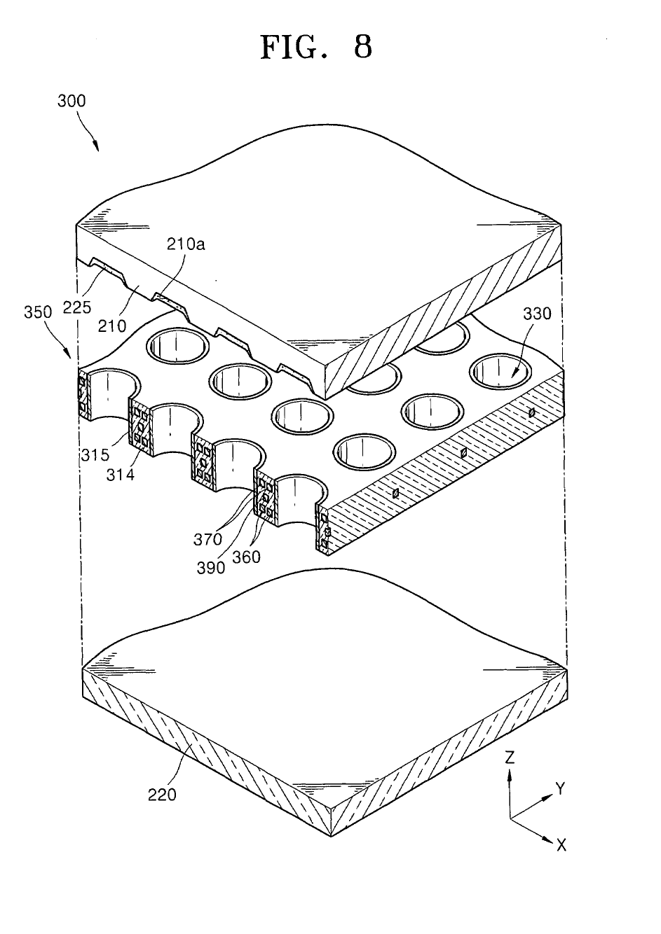

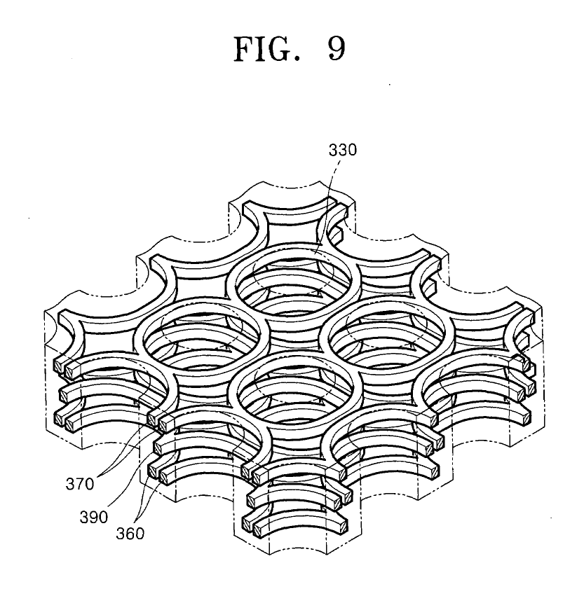

According to another embodiment of the present invention, a PDP may have a three-electrode structure, as illustrated in FIGS. 8-9. In particular, a PDP 300 may be similar to the PDP 200 with the exception that the PDP 300 may include a plurality of address electrodes 390. First and second discharge electrodes 360 and 370, first and second substrates 310 and 320, and discharge cells 330 are similar to the first and second discharge electrodes 260 and 270, first and second substrates 210 and 220, and discharge cells 230 described previously with respect to the PDP 200, and therefore, their description will not be repeated herein.

As illustrated in FIG. 8-9, each of the plurality of the address electrodes 390 may include a plurality of tangential identical circles arranged sequentially into a single linear array along the y-axis, such that each address electrodes 390 may be positioned at a right angle to the plurality of first and second discharge electrodes 360 and 370. Each circle of the plurality of circles of each address electrodes 390 may be positioned between respective circles of respective first and second discharge electrode 360 and 370 to surround a discharge cell 330, such that each discharge cell 330 may be surrounded by three concentric circles. The plurality of address electrodes 390 may be arranged parallel to one another, such that a small gap may be formed between every two address electrodes 390. Additionally, a plane formed by the address electrodes 390 may be parallel to, i.e., positioned in the xy-plane, and positioned between the planes formed by the first and second discharge electrodes 360 and 370.

In this respect, it should be noted that even though the present embodiment, illustrated with respect to FIGS. 8-9, includes identical circles, wherein the address electrodes 390 are positioned between the first and second discharge electrodes 360 and 370, other configurations of electrode shapes and positions are not excluded from the scope of the present invention. For example, the address electrodes 390 may be positioned adjacent to the first substrate 316, on the second substrate 320, and so forth.

An exemplary method of driving the PDP 300 of FIGS. 8-9 will now be described. First, address discharge may be generated between the first discharge electrodes 360 and address electrodes 390 to select discharge cells 330 to be operated. Next, AC sustain voltage may be applied between the first and second discharge electrodes 360 and 370 of the selected discharge cells 330 to generate a sustain discharge and, subsequently, UV light emission therein. In this respect, it should be noted that the sustain discharge may occur in the entire volumetric space defining each of the discharge cells 330. Subsequently, the UV light may be emitted upward toward the first substrate 310 to excite the plurality of phosphor layers 325 thereon. Excitation of the phosphor layers 225 may emit visible light to form images.

In the present invention, formation of exhaustion paths between the exhaustion hole and the sealed space between the substrates and the sealing members, i.e., area containing discharge cells, may facilitate an efficient removal of impurity gas therefrom, thereby enhancing the exhaustion capacity of the PDP.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate;
a second substrate spaced apart from the first substrate, the second substrate having an exhaustion hole;
an electrode sheet disposed between the first substrate and the second substrate, the electrode sheet comprising barrier ribs to define a plurality of discharge cells, a pair of discharge electrodes to generate a discharge in the discharge cells and at least one exhaustion path;
a first sealing member between the first substrate and the electrode sheet; and
a second sealing member between the second substrate and the electrode sheet.

2. The plasma display panel of claim 1, wherein the electrode sheet is partitioned into a discharge area where discharge substantially occurs and an undischarge area surrounding the discharge area, and the exhaustion path is formed in the undischarge area of the electrode sheet.

3. The plasma display panel as claimed in claim 2, wherein the exhaustion path is positioned along an inner perimeter of the electrode sheet.

4. The plasma display panel as claimed in claim 2, wherein the exhaustion path has a shape of a looped curve.

5. The PDP as claimed in claim 1, wherein the exhaustion hole is in a region of the second substrate corresponding to the undischarge area of the electrode sheet.

6. The PDP of claim 5, wherein the exhaustion hole is aligned with a region on the exhaustion path.

7. The PDP of claim 5, wherein the exhaustion hole is below a region of the exhaustion path.

8. The PDP as claimed in claim 1, wherein the electrode sheet includes two exhaustion paths.

9. The PDP as claimed in claim 8, wherein each exhaustion path is on a different surface of the electrode sheet.

10. The PDP as claimed in claim 9, wherein the two exhaustion paths are aligned.

11. The PDP of claim 1, wherein the electrode sheet extends beyond sides of the first substrate and the second substrate.

12. The PDP of claim 1, wherein grooves are formed in portions of the first substrate facing the discharge cells and phosphor layers are disposed inside the grooves.

13. The PDP as claimed in claim 1, wherein the electrode sheet includes a plurality of first discharge electrodes spaced apart from one another and a plurality of second discharge electrodes spaced apart from one another, the plurality of the first discharge electrodes extending on a plane parallel to a plane of the second discharge electrodes, each of the first discharge electrodes and the second discharge electrodes surround at least one portion of each discharge cell disposed in a predetermined direction.

14. The PDP as claimed in claim 13, wherein each of the plurality of first discharge electrodes crosses the plurality of second discharge electrodes.

15. The PDP as claimed in claim 13, wherein the first discharge electrodes and the second discharge electrodes extend parallel to each other.

16. The PDP as claimed in claim 15, wherein the electrode sheet further comprises a plurality of address electrodes on a plane spaced apart from the plane of the plurality of the first discharge electrodes and the plane of the plurality of the second discharge electrodes, each of the address electrodes surrounds at least one portion of each discharge cell disposed in a predetermined direction.
